(19) United States
(12) Patent Application Publication
(10) Pub. No.: US 2026/0135840 A1
(43) Pub. Date: May 14, 2026

(54) Autonomous Quantum-Secure Mesh Networking System

(71) Applicant: Richard D'Souza, Langley (CA)

(72) Inventor: Richard D'Souza, Langley (CA)

(21) Appl. No.: 19/431,282

(22) Filed: Dec. 23, 2025

(30) Foreign Application Priority Data
Dec. 6, 2025 (CA) 3294874

(51) Int. Cl. H04L 9/40; H04L 9/08

(52) U.S. Cl. CPC H04L 63/0435; H04L 9/0852; H04L 63/0861

(57) ABSTRACT

The present disclosure provides an autonomous quantum-secure mesh networking system comprising a server including a memory and a processor operatively coupled to the memory. The processor receives communication data from at least one computing device for secure transmission across a communication network, generates a symmetric quantum encryption key using a quantum key distribution process, derives a quantum identity-bound key material by combining the symmetric quantum encryption key with a quantum identity root for authenticating communication endpoints, evaluates a trust score of each available transmission path using a trust model to select a secure transmission path, encrypts communication data and associated session metadata using the symmetric quantum encryption key, records an identifier of each encrypted packet and at least one trust-related parameter of the secure transmission path on a blockchain-based distributed ledger and transmits the encrypted communication data across the selected secure transmission path.

### FIELD OF THE INVENTION

The present disclosure generally relates to secure communication systems. Further, the present disclosure particularly relates to an autonomous quantum-secure mesh networking system.

### BACKGROUND

The background description includes information that may be useful in understanding the present invention. It is not an admission that any of the information provided herein is prior art or relevant to the presently claimed invention, or that any publication specifically or implicitly referenced is prior art.

Quantum communication networks have gained significant attention in recent years due to the increasing need for secure communication over digital infrastructures. Conventional communication systems based on classical cryptographic methods rely heavily on computational hardness assumptions for confidentiality and integrity of transmitted data. However, the rapid advancement of quantum computing technologies threatens to compromise such conventional cryptographic schemes. Consequently, quantum-based communication techniques have been proposed and implemented to enable security against quantum-enabled adversaries. Various methods and systems have been developed to implement secure key distribution, authentication and transmission protocols in communication networks.

One well-known technique is the utilization of quantum key distribution protocols such as BB84 and E91. Such protocols establish cryptographic keys between two endpoints using principles of quantum mechanics, specifically the no-cloning theorem and measurement disturbance. Quantum key distribution enables secure establishment of symmetric encryption keys over untrusted channels. However, deployment of quantum key distribution in practical network environments faces several problems. Quantum key distribution requires dedicated quantum communication channels such as optical fibers or free-space links which suffer from high attenuation over long distances. Furthermore, quantum key distribution systems require specialized photon detectors and hardware modules which increase cost and complexity. Reliability of quantum key distribution is further compromised by environmental disturbances and noise which frequently cause key generation rates to be very low. As a result, scalability of such systems across large networks is severely restricted.

Another prominent approach employs blockchain-based security frameworks for communication networks. Blockchain systems maintain distributed ledgers that record transactions or communication events in an immutable manner. Such systems enable enhanced transparency and trust in peer-to-peer communication networks. However, conventional blockchain frameworks suffer from high latency and energy consumption due to consensus algorithms such as proof-of-work and proof-of-stake. Furthermore, blockchain-based systems by themselves do not guarantee resistance against quantum computing attacks since the underlying cryptographic primitives such as elliptic curve digital signatures or RSA-based schemes are vulnerable to quantum algorithms like Shor's algorithm. Hence, reliance on blockchain as a stand-alone solution for quantum-secure communication remains problematic.

Further, hybrid trust models have also been introduced to secure communication paths in mesh networks. Such models evaluate transmission routes based on multiple parameters such as latency, reliability, bandwidth and historical trustworthiness of nodes. However, existing trust evaluation systems lack quantum-safe integration. Moreover, conventional trust scoring methods are often static, making them susceptible to manipulation by malicious nodes. Trust propagation in such models may also introduce vulnerabilities due to false recommendations or collusion attacks among compromised nodes. Hence, secure communication using conventional trust scoring methods is subject to compromise in hostile environments.

Collation of the above discussion reveals that current quantum key distribution systems are limited by hardware and scalability challenges, blockchain-based security frameworks are limited by computational inefficiencies and vulnerability to quantum attacks, and hybrid trust models are limited by lack of dynamic quantum-safe integration. Moreover, other conventional communication security systems suffer from additional drawbacks such as reliance on public key cryptography vulnerable to quantum computing, absence of authentication mechanisms strongly bound to identities and lack of end-to-end assurance in dynamic mesh networking environments.

In light of the above discussion, there exists an urgent need for solutions that overcome the problems associated with conventional systems and techniques for providing secure communication over digital networks against both classical and quantum-enabled adversaries.

### SUMMARY

The following presents a simplified summary of various aspects of this disclosure in order to provide a basic understanding of such aspects. This summary is not an extensive overview of all contemplated aspects and is intended to neither identify key or critical elements nor delineate the scope of such aspects. Its purpose is to present some concepts of this disclosure in a simplified form as a prelude to the more detailed description that is presented later.

The following paragraphs provide additional support for the claims of the subject application.

An objective of the present disclosure is to enable secure communication across mesh networks resistant to both classical and quantum-enabled threats. Another objective of the present disclosure is to provide authentication and trust evaluation mechanisms integrated with quantum key distribution to assure end-to-end security. Further objective of the present disclosure is to enable verifiable storage of security-related events using a distributed ledger.

In an aspect, the present disclosure provides an autonomous quantum-secure mesh networking system comprising a server comprising a memory and a processor operatively coupled to the memory. The processor receives communication data from at least one computing device for secure transmission across a communication network, generates a symmetric quantum encryption key using a quantum key distribution process, derives a quantum identity-bound key material by combining the symmetric quantum encryption key with a quantum identity root for authenticating communication endpoints, evaluates a trust score of each available transmission path using a trust model to select a secure transmission path, encrypts communication data and associated session metadata using the symmetric quantum encryption key, records an identifier of each encrypted packet and at least one trust-related parameter of the secure transmission path on a blockchain-based distributed ledger and transmits the encrypted communication data across the selected secure transmission path.

Further, such a system enables enhanced confidentiality of transmitted data, reliable authentication of endpoints and integrity verification of communication events. Moreover, such a system enables efficient routing decisions based on adaptive trust evaluation while maintaining transparency and auditability using the distributed ledger.

In another aspect, the present disclosure provides a method for securely transmitting communication data over a quantum-secure mesh network. The method comprises utilizing a server comprising a processor operatively coupled to a memory. The processor receives communication data from at least one computing device for secure transmission across a communication network, generates a symmetric quantum encryption key using a quantum key distribution process, derives a quantum identity-bound key material by combining the symmetric quantum encryption key with a quantum identity root for authenticating communication endpoints, evaluates a trust score of each available transmission path using a trust model to select a secure transmission path, encrypts communication data and associated session metadata using the symmetric quantum encryption key, records an identifier of each encrypted packet and at least one trust-related parameter of the secure transmission path on a blockchain-based distributed ledger and transmits the encrypted communication data across the selected secure transmission path.

Further, such a method enables dynamic management of encryption keys, adaptive rerouting of data based on trust score variations and secure storage of operational metadata. Moreover, such a method enables quantum-safe transmission with resilience against anomalies and threats.

In a further aspect, the present disclosure provides a non-transitory computer-readable storage medium comprising executable instructions that when executed by a processor of a server enable secure transmission of communication data over a quantum-secure mesh network. The processor performs receiving of communication data from at least one computing device for secure transmission across a communication network, generating of a symmetric quantum encryption key using a quantum key distribution process, deriving of a quantum identity-bound key material by combining the symmetric quantum encryption key with a quantum identity root for authenticating communication endpoints, evaluating of a trust score of each available transmission path using a trust model to select a secure transmission path, encrypting of communication data and associated session metadata using the symmetric quantum encryption key, recording of an identifier of each encrypted packet and at least one trust-related parameter of the secure transmission path on a blockchain-based distributed ledger and transmitting of the encrypted communication data across the selected secure transmission path.

Further, such a storage medium enables persistent deployment of secure transmission functions across diverse computing environments. Moreover, such a storage medium enables consistent implementation of quantum-secure protocols with verifiable audit trails.

### BRIEF DESCRIPTION OF THE DRAWINGS

The features and advantages of the present disclosure would be more clearly understood from the following description taken in conjunction with the accompanying drawings in which:

FIG. 1 illustrates an autonomous quantum-secure mesh networking system (100), in accordance with the embodiments of the present disclosure.

FIG. 2 illustrates a method (200) for securely transmitting communication data over a quantum-secure mesh network, in accordance with the embodiments of the present disclosure.

FIG. 3 illustrates a process flow for quantum key establishment using a quantum key distribution (QKD) mechanism, in accordance with the embodiments of the present disclosure.

FIG. 4 illustrates a process for generating an identity-bound derived key using biometric and hardware integration, in accordance with the embodiments of the present disclosure.

FIG. 5 illustrates a quantum key distribution (QKD) based secure key exchange architecture between two communicating entities, Alice and Bob, in accordance with the embodiments of the present disclosure.

FIG. 6 illustrates a system architecture for autonomous selection of a secure transmission path based on dynamic trust evaluation, in accordance with the embodiments of the present disclosure.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to claim those skilled in the art to practice the invention. Other embodiments may be utilized, and structural, logical, and electrical changes may be made without departing from the scope of the present invention. The following detailed description is, therefore, not to be taken in a limiting sense, and the scope of the present invention is defined only by the appended claims and equivalents thereof.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Pursuant to the “Detailed Description” section herein, whenever an element is explicitly associated with a specific numeral for the first time, such association shall be deemed consistent and applicable throughout the entirety of the “Detailed Description” section, unless otherwise expressly stated or contradicted by the context.

As used herein, the term “autonomous quantum-secure mesh networking system” refers to a communication framework that functions separately to authenticate, manage, and protect digital information across nodes (interconnected). The mesh topology of the autonomous quantum-secure mesh networking system means that every node acts as a transceiver, which provides redundancy by allowing data to be sent along different paths. The quantum-secure system utilizes methods that are based on quantum-mechanics, wherein the quantum-secure system is used to protect information against both quantum and classical computational attacks. Said system may operate over wired or wireless channels, comprising optical fibre backbones, wireless mesh topologies, or satellite-assisted links. Examples of applications of such a system are government communication necessitating confidentiality, financial transaction systems that need security, healthcare management of records, and industrial control where integrity in communication is a must. By relying on autonomous operation, such a system dynamically adapts to changing network conditions without requiring manual intervention, thereby maintaining continuous secure communication across distributed environments.

As used herein, the term “server” refers to a computing unit responsible for handling requests, performing computational tasks, and managing communication sessions within a larger system. Such a server comprises hardware or virtualised resources such as processors, memory, and input-output interfaces. The server may be deployed in a datacentre, operated as a cloud-based virtual instance, or provided as an edge computing device located near end users. Said server receives data from client devices, executes cryptographic processes, generates and distributes encryption materials, and records relevant events on secure ledgers. The server may also coordinate trust-based routing by computing parameters for network paths. The servers are selected from rack-mounted computing hardware, cloud-hosted virtual servers, or compact edge servers installed in 5G infrastructure.

As used herein, the term “memory” refers to an element of a computing system that stores digital data and instructions for access by a processor. The memory is volatile, such as dynamic random-access memory used for temporary storage, or non-volatile, such as flash drives, hard disks, or solid-state drives used for persistent data storage. Said memory stores cryptographic keys, communication data, routing information, operational parameters, and program instructions necessary for system operation. Memory is employed for maintaining blockchain records, session states, and trust evaluation parameters. Memory is selected from DDR4 and DDR5 random access modules, NAND flash chips, magnetic disk drives, or non-volatile DIMMs.

As used herein, the term “processor” refers to a component that performs logical and arithmetic operations on data. The processor retrieves instructions from memory, decodes the instructions, and executes operations that involve data encryption, trust evaluation, routing selection, and ledger updates. The processor comprises general-purpose central processing units, graphics processing units, application-specific integrated circuits, or field-programmable gate arrays. Said processor can be implemented in a single-core or multi-core configuration depending on the computational requirement of the system. Examples comprise processors manufactured under the Intel Xeon series, AMD EPYC architecture, ARM Cortex processors, or RISC-V based designs. The processor may also coordinate cryptographic accelerators to perform encryption or decryption functions. By performing secure computation, such a processor enables execution of functions required for transmission, encryption, authentication, and recording of communication events across distributed secure networks.

As used herein, the term “communication data” refers to digital content transmitted across a network between at least two computing entities. The communication data consists of comprising text files, numerical records, voice streams, video transmissions, machine-generated messages, etc. Communication data is the main payload of a transmission and is typically accompanied by metadata representing session parameters or routing information. Said data requires encryption for confidentiality, authentication for endpoint verification, and integrity protection against modification. Examples of communication data comprise financial transaction details transmitted between banks, electronic mail content exchanged over internet protocols, multimedia streams delivered for conferencing applications, or industrial control commands transmitted in automation systems. The communication data is formatted and packaged for transmission using standard networking methods and is subject to storage, processing, and secure distribution through cryptographic methods within the server environment. Such data represents the information asset requiring preservation within a secure networking environment.

As used herein, the term “computing device” refers to an electronic unit capable of executing programmed instructions and interacting with communication systems. Such a computing device may comprise personal computers, laptops, smartphones, tablets, embedded devices, or specialised hardware within industrial or healthcare environments. A computing device typically comprises input-output interfaces, processors, and memory and is capable of generating, receiving, and transmitting communication data. Said computing device may operate as a client node within a secure network, sending requests to a server or participating as an endpoint in authentication processes. Examples of computing device comprises a smartphone sending encrypted messages, a medical sensor device transmitting patient data, a laptop accessing financial platforms, or any other known device capable of sharing data. By participating in secure communication, such a computing device enables exchange of data that requires confidentiality, authenticity, and integrity. Such computing devices are essential endpoints within a mesh-based communication system and interact with servers for secure data exchange.

As used herein, the term “communication network” refers to an infrastructure comprising interconnected nodes and links for the exchange of digital information. Such a network may be physical or wireless and may incorporate multiple layers comprising data link, network, and transport protocols. A communication network may be global such as the internet, local such as a local area network, or hybrid combinations that integrate fibre optics, wireless signals, and satellite channels. Said communication network is used for transmitting communication data between servers, computing devices, and other endpoints. Communication networks are selected from, mobile communication networks used for voice and data services, enterprise networks providing secure data access, or industrial networks interconnecting machinery.

As used herein, the term “symmetric quantum encryption key” refers to a cryptographic key generated using quantum key distribution and applied in symmetric encryption. The symmetric quantum encryption key is used identically for both encryption and decryption of communication data between two endpoints. Symmetric quantum encryption key is achieved based on quantum properties of particles such as photons that are not possible to intercept or copy without being noticed because of measurement disturbance principles. Symmetric quantum encryption key is utilized to assure confidentiality of communication data and related metadata. Examples of symmetric quantum encryption key are the keys, which are produced with protocols like BB84 or E91, used in encryption techniques such as the Advanced Encryption Standard. Said keys are short-lived and periodically regenerated to maintain security during ongoing communication sessions. Such a key forms a core security element by providing a quantum-resistant method for securing digital information in distributed systems.

As used herein, the term “quantum key distribution process” refers to a procedure for generating and exchanging cryptographic keys between two communication entities by utilising quantum mechanical properties. Such a process employs quantum states of particles such as photons to encode key information in a manner where any attempt of interception or measurement by an unauthorised third party alters the quantum state and is therefore detectable. Said process uses established protocols such as BB84, E91, or decoy state methods, where photons are transmitted through optical fibres or free-space links. Practical implementation often involves photon sources, polarisation controllers, beam splitters, photon detectors, etc. By applying the quantum key distribution process, endpoints establish symmetric encryption keys that are resistant to computational attacks from both classical and quantum computers. Examples of usage comprise secure communications between data centres, interbank communication links, and government communication systems. Such a process enables creation of cryptographic keys that form the basis for secure encrypted communication across networks.

As used herein, the term “quantum identity-bound key material” refers to a cryptographic element generated by combining the symmetric quantum encryption key with identity-specific information to create a unique credential for authentication. Such key material integrates identity-binding elements comprising biometric vectors, device-specific hardware signatures, or predefined digital identifiers with quantum-derived keys. By forming such combination, the key material encrypts communication data and also verifies that the endpoints involved in communication are authentic and not impersonated. Identity inputs are selected from fingerprint hashes, iris scans, facial recognition vectors, or trusted platform module signatures. The resulting quantum identity-bound key material is used for initiating sessions, validating access requests, and preventing replay or impersonation attacks. Said key material may be regenerated periodically to prevent correlation and may be stored in protected memory for future verification. Such an element strengthens communication systems by binding cryptographic functionality to endpoint identity attributes.

As used herein, the term “quantum identity root” refers to a foundational identity element from which identity-bound key material is derived. Quantum identity root is a persistent identity anchor that will be the same for an endpoint throughout multiple communication sessions. The quantum identity root consists of a unique biometric template, a device hardware fingerprint, a secure enclave identifier, or other immutable properties that can be combined with quantum encryption keys for generating session-specific authentication materials. Examples of quantum identity roots comprise a cryptographically hashed DNA marker, a motherboard-integrated hardware signature, or a root key stored in a tamper-resistant chip. Said root provides a non-replicable identity component that, when combined with dynamically generated quantum keys, results in authentication credentials resistant to forgery or duplication. The quantum identity root may be stored in secure storage or generated through trusted physical characteristics. Such a root serves as the baseline identity parameter enabling strong endpoint authentication in secure networking environments.

As used herein, the term “communication endpoints” refers to entities participating in data exchange across a communication system.

Such endpoints may comprise servers, client devices, embedded controllers, or specialised equipment connected through a communication network. Communication endpoints generate, receive, and process communication data, and are responsible for maintaining security functions such as encryption, authentication, and trust evaluation. Examples of endpoints comprise a mobile phone sending encrypted text, a healthcare device transmitting medical records, a corporate server receiving financial transaction information, or a remote workstation accessing secure databases. Said endpoints may be static in fixed locations or dynamic as in mobile communication nodes. Endpoints can operate as originators of data, recipients of data, or intermediaries forwarding packets. Each endpoint is associated with identity attributes and cryptographic keys that establish trust within the network. Such communication endpoints represent the active nodes across which secure transmissions occur within distributed and mesh-based communication systems.

As used herein, the term “trust score” refers to a numerical or categorical value assigned to a communication path or node, indicating the reliability and security of using such a path for transmitting data. The trust score is computed by evaluating parameters such as past behaviour, observed performance, latency, packet loss, cryptographic strength, and adherence to access policies. Said trust score is adaptive, dynamically recalculated in response to network changes or new information. Examples comprise trust scores ranging from zero to one, percentage-based values, or ordinal categories such as high, medium, and low. The trust score controls the choice of whether a path is chosen for encrypted communication or skipped in favor of others. Trust scoring models incorporates machine learning-based inference, rule-based assessments or federated evaluations. The trust score is retained and periodically updated to capture evolving network conditions in order to support secure routing and malicious path exploitation prevention in mesh networks.

As used herein, the term “transmission path” refers to the physical or logical route through which communication data travels between endpoints. Such a path may comprise one or more links, routers, switches, or intermediate devices in wired or wireless configurations. Transmission paths may vary in quality depending on metrics such as signal strength, bandwidth availability, error rates, and latency. Examples comprise optical fibre links carrying photon-based signals, wireless mesh hops between access points, or satellite connections spanning long distances. A transmission path is direct between two endpoints or indirect through multiple nodes. Said transmission path is evaluated for security using trust scores and monitored for anomalies that indicates attempts of interception. Selection of an appropriate transmission path influences communication quality, reliability, and security.

As used herein, the term “trust model” refers to a framework or methodology used to calculate and maintain trust scores for nodes and paths within a communication system. Such a model incorporates criteria comprising historical performance, observed behaviour, cryptographic compliance, and feedback from other nodes. Trust models may be static, rule-based systems, or dynamic adaptive systems incorporating federated inference or statistical evaluation. Said trust model provides the quantitative or qualitative evaluation that determines which transmission paths are acceptable for secure communication. Examples range from Bayesian trust models, fuzzy scoring systems based on fuzzy logic, and federated machine learning-based solutions to distributed networks. A trust model takes into account, factors like packet delivery ratios, latency, error rates, and outcomes of anomaly detection. By continuously updating trust values, the trust model makes sure that data transmission occurs over routes considered reliable and authentic.

As used herein, the term “session metadata” refers to additional information associated with a communication session apart from the primary data. Said metadata consists of information regarding session establishment, duration, endpoints, cryptographic parameters, and routing determinations. Session metadata is automatically created during the communication exchange and stored for verification, auditing, and management. Examples comprise timestamps marking the beginning and end of a session, identifiers of participating devices, encryption keys used for the session, or quality-of-service parameters. Said session metadata is itself encrypted alongside the communication data to prevent disclosure of sensitive information about session structure. Session metadata provides contextual information that allows reconstruction, verification, and auditing of communication events. In secure networking systems, session metadata supports functions such as key lifecycle management, trust evaluation, and blockchain-based logging.

As used herein, the term “blockchain-based distributed ledger” refers to a digital record-keeping structure that maintains sequential entries in a decentralised and immutable manner across multiple nodes. Such a ledger stores records of transactions, events, or data packets without reliance on a central authority, thereby reducing the possibility of alteration. The distributed nature of the ledger means that each participant maintains a copy of the records, and any update is validated by a consensus process. Said ledger stores encrypted identifiers of packets, key lifecycle events, and trust-related parameters. Blockchain-based distributed ledgers are selected from those using permissioned access such as Hyperledger Fabric or consortium-based systems applied in private networks. Entries in the ledger may comprise cryptographic hashes, timestamps, and node identities. The blockchain-based distributed ledger provides historical traceability, verifiable authenticity, and prevention of retroactive modification. Such a ledger is applied in communication systems where transparency, auditability, and tamper resistance are required.

As used herein, the term “encrypted packet” refers to a formatted data unit that has been transformed using cryptographic techniques to prevent unauthorised access or alteration. An encrypted packet comprises payload data, metadata, and address information, all of which are encrypted by symmetric/asymmetric means. Said encrypted packet travels across communication networks, and only authorized endpoints possessing correct cryptographic keys can decrypt and interpret the contents. Some examples of encrypted packets are Internet Protocol Security packets, Transport Layer Security records, or virtual private network encapsulated messages. The encryption can involve application of symmetric quantum encryption keys created using quantum key distribution. Encrypted packets assure confidentiality and integrity of data being transmitted are safe against interception or tampering through encryption. Encrypted packets are forwarded through intermediate devices, but contents are not accessible in their encrypted form without decryption keys.

As used herein, the term “quantum random number generator” refers to a device that generates random values by utilizing inherent quantum uncertainty. Said generator uses processes like timing of photon emission, quantum vacuum fluctuations, or radioactive decay occurrences to generate entropy that is non-reproducible and unpredictable (classical methods). Said generator outputs entropy values used in cryptographic processes, comprising generation of cryptographic seeds or symmetric encryption keys. Examples comprise generators based on single-photon detectors measuring arrival times, phase noise in lasers, or quantum tunnelling events in semiconductors. Quantum random number generators are distinct from classical pseudo-random number generators, as the produced numbers cannot be predicted by algorithms or previous states. Such generators provide a foundation for cryptographic systems by supplying entropy that is resistant to modelling or prediction. The quantum random number generator forms a trusted entropy source in communication environments requiring quantum-secure key material.

As used herein, the term “entropy values” refers to numerical sequences produced by physical or computational processes that bear unpredictability and randomness. Entropy values are needed for secure cryptographic processes to avoid predictability in keys or seeds generated. Sources of entropy values comprises quantum random number generators, hardware noise circuits, environmental fluctuations, or user-generated inputs. Said entropy values are transformed into usable cryptographic materials, such as seeds or encryption keys, that secure communication systems against adversarial prediction. Some examples of entropy levels are bit streams from radioactive decay counters, oscillators' timing jitter, or photon detection events. Entropy quality is often measured against thresholds for randomness, bias, and uniform distribution. In secure communication systems, entropy values must meet predefined thresholds before being accepted for cryptographic use. Such entropy values provide the unpredictable foundation for key generation, session initiation, and other cryptographic functions in distributed networks.

As used herein, the term “cryptographic seed” refers to an original random value from which additional cryptographic keys, pseudo-random numbers, or security parameters are based. Such a seed is often generated using entropy values provided by hardware random number generators, comprising quantum sources, to affirm unpredictability. Said cryptographic seed may serve as input to deterministic algorithms such as pseudo-random number generators or key derivation functions, producing sequences suitable for encryption or authentication tasks. Some examples of cryptographic seeds are 256-bit random bit strings applied in elliptic curve cryptography or seeds from photon detection events in quantum key distribution. The security of the derived cryptographic material is directly reliant on the unpredictability and quality of the seed. In communication systems, cryptographic seeds may be periodically regenerated to maintain session security. Such cryptographic seeds form the starting point for secure key management, encryption policies, and authentication protocols in networking frameworks.

As used herein, the term “entropy fingerprints” refers to unique identifiers derived from validated values of entropy. Such fingerprints capture distinguishing statistical characteristics of entropy sequences and may serve as verifiable markers of entropy origin and quality. Said entropy fingerprints may be stored alongside temporal anchors and device identity attributes in distributed ledgers for auditing. Examples comprise hash representations of entropy sequences, statistical profiles of randomness, or signature patterns generated by entropy validation processes. By recording entropy fingerprints, systems can prove that key material originated from specific entropy sources and that no tampering occurred during generation. Such fingerprints provide accountability, traceability, and reproducibility for cryptographic operations. Entropy fingerprints may also be compared against baseline profiles to detect deviations indicating compromised entropy sources. In secure networks, entropy fingerprints strengthen trust in key generation and provide evidence of origin authenticity for cryptographic elements.

As used herein, the term “temporal event anchors” refers to time-stamped records associated with events occurring in cryptographic or communication processes. Such anchors are generated to provide chronological ordering, correlation, and validation of activities such as key generation, entropy validation, or packet transmission. Temporal event anchors comprise both absolute times, such as coordinated universal time stamps, and relative times measured by local system clocks. Examples comprise time markers associated with blockchain entries, logs of session initiation, or event triggers in entropy regeneration. Said temporal event anchors may be recorded in distributed ledgers for non-repudiation and auditing. By correlating cryptographic events with time data, temporal event anchors facilitate reconstruction of system behaviour and anomaly detection. Such anchors are vital for verifying when specific cryptographic actions occurred and provide historical context in distributed environments. Temporal event anchors allow for assure tracing of operations among nodes in secure communication systems.

As used herein, the term “device identity attributes” refers to unique properties/attributes associated with a computing or networking device, which distinguish said computing or networking device from other devices. Said attributes comprises hardware-based identifiers, software-based signatures, or cryptographic keys embedded in trusted components. Examples comprise processor serial numbers, motherboard identifiers, trusted platform module certificates, or network interface card addresses. Said device identity attributes may also comprise biometric data if the device integrates human identification mechanisms. Device identity attributes are used for authenticating devices, authorising access to networks, and binding cryptographic operations to specific hardware. By recording such attributes in distributed ledgers alongside entropy fingerprints and event anchors, systems maintain verifiable proof of device participation in cryptographic processes. Device identity attributes provide assurance that cryptographic keys and communication sessions are associated with trusted devices (not malicious replicas).

As used herein, the term “quantum bit error rate” refers to a measurable ratio indicating the proportion of incorrect quantum bits received during a quantum key distribution process in comparison to the total transmitted bits. Such a measure is used to determine whether eavesdropping attempts, noise, or physical disturbances have compromised the transmission of quantum states. Said quantum bit error rate is typically calculated by comparing a subset of transmitted and received qubits that have been publicly disclosed between communicating endpoints. Examples comprise error rates measured during photon polarisation alignment in BB84 protocols or phase encoding discrepancies in entanglement-based schemes. A low quantum bit error rate indicates stable channel conditions and secure key generation, while a high value suggests interception or channel degradation. Acceptable thresholds vary depending on protocol, often within ranges of less than 11 percent for practical systems. By continuously monitoring the quantum bit error rate, systems detect security risks and decide whether to discard generated keys or terminate ongoing distribution sessions.

As used herein, the term “optical fiber medium” refers to a physical transmission channel that utilises strands of glass or plastic to carry light signals over long distances. Such a medium guides photons through total internal reflection, enabling high bandwidth and low attenuation compared to traditional metallic cables. Optical fiber medium may be used for carrying quantum states in quantum key distribution as well as classical data in secure networking systems. Said medium may comprise single-mode fibers for long-distance high-capacity transmission or multi-mode fibers for shorter connections. Examples comprise submarine communication fibers connecting continents, metro fibers interlinking data centres, and access-level fibers connecting end users. Optical fiber mediums experience losses due to bending, scattering, or splicing imperfections. In quantum applications, maintaining alignment and minimising noise are critical for preserving qubit fidelity. Such optical fiber mediums enable high-speed, secure, and long-distance transmission of communication data and quantum key materials between distributed endpoints.

As used herein, the term “endpoint-local generation” refers to a process of creating encryption keys within two communication endpoints (directly), rather than exchanging the keys over a network. Aforesaid process of creating encryption keys prevents exposure of generated key material during transmission, thus reducing risks of interception or manipulation. Endpoint-local generation may involve each endpoint using identical entropy sources, deterministic seed material, or synchronised quantum random number generators to derive matching symmetric encryption keys. Examples comprise key agreement based on simultaneous quantum entropy sampling or deterministic expansion of pre-shared seeds stored in secure hardware. Said process may be coordinated by servers controlling timing and entropy validation while keys remain confined within device boundaries. Endpoint-local generation provides an alternative to direct distribution channels, especially when communication networks are vulnerable to interception. Such endpoint-local generation of encryption keys enhances confidentiality by maintaining all sensitive cryptographic material within trusted computing devices at communication endpoints.

As used herein, the term “quantum entropy output” refers to the raw unpredictable data stream generated by processes that rely on quantum mechanical randomness. Such output may be obtained from measurements of photon polarisation, quantum tunnelling current, or vacuum fluctuation noise. Said quantum entropy output forms the basis for cryptographic seed generation, unpredictability and resistance against adversarial modelling. Examples comprise bit streams generated by single-photon avalanche detectors, phase noise in coherent light sources, or amplified spontaneous emission in optical systems. The quantum entropy output is processed through randomness extractors, statistical tests, hash functions, etc., to eliminate bias and produce uniform distributions. Validated quantum entropy outputs are used to create symmetric encryption keys, session identifiers, or other secure parameters. Such quantum entropy output provides a fundamental randomness resource required for quantum-secure cryptographic processes and supports generation of security materials that cannot be replicated or predicted by computational means.

As used herein, the term “photon-based transmission path” refers to a communication channel in which information is carried by photons. Said path involves optical fibers, free-space optical channels, or integrated photonic circuits. Photon-based transmission paths are used in both classical optical communication and quantum key distribution. Said paths provide advantages of low attenuation, high bandwidth, and natural compatibility with quantum state encoding. Examples comprise terrestrial optical fiber backbones connecting urban centres, satellite-to-ground optical channels supporting long-distance quantum communication, and on-chip photonic circuits used for secure short-range links. Photon-based transmission paths are evaluated based on factors selected from signal-to-noise ratio, bit error rate, optical loss, alignment stability, environmental influences, etc. By optimising photon-based transmission paths, systems maintain communication stability, reduce error rates, and preserve quantum state fidelity.

As used herein, the term “signal-to-noise ratio” refers to a level of an intended signal relative to the level of background noise in a communication system. Signal-to-noise ratio is stated as a ratio or a decibel value and is utilized to assess the quality of transmission channels. A higher signal-to-noise ratio indicates clearer communication with fewer errors, while a lower ratio indicates degradation due to interference, noise, or environmental conditions. Said signal-to-noise ratio is particularly relevant for photon-based channels where detection systems must differentiate quantum signals from background fluctuations. Some examples comprise computing ratios for optical transmission via fibers, wireless signals with interference, or free-space channels open to atmospheric conditions. Measurement of signal-to-noise ratio influences selection of transmission paths, adjustment of error correction techniques, and determination of trust scores. Such signal-to-noise ratio provides an essential parameter for maintaining reliable, accurate, and secure data transmission across communication systems.

As used herein, the term “virtualized quantum key distribution tunnel” refers to a logical channel which is created between the ends of a communication system in order to transmit quantum-generated cryptomaterials and encrypted information. Said tunnel is established across existing network hardware, offering a secure overlay for the transportation of entropy packets, key data, or encrypted communications streams. The virtualization aspect refers to abstraction of physical resources, enabling multiple logical tunnels to coexist over shared links. The aforementioned tunnel is dynamically set up and maintained according to trust scores, channel availability, and endpoint demands. Examples comprise creating virtual tunnels across multiprotocol label switching networks, secure overlays on internet backbones, or dynamically rerouted channels in software-defined networks. The tunnel that is virtualized for quantum key distribution assures confidentiality, integrity, and separation of traffic from the leakage of quantum-generated security material into insecure channels.

As used herein, the term “side-channel anomaly” refers to an unintended variation or disturbance observed during cryptographic or communication processes that may reveal sensitive information. Such anomalies arise from indirect characteristics of system operation rather than from direct cryptographic computation. Side-channel anomalies may comprise timing variations, power consumption fluctuations, electromagnetic emissions, or manipulation attempts such as photon blinding. Said anomalies are used by attackers to deduce cryptographic keys or interfere with key generation. Such differences are variations in photon detection times, changes in entropy output due to external interference, or injected laser signals for swamping detectors. Detection of side-channel anomalies is by monitoring system parameters and comparing them to preset baselines. Countermeasures comprise entropy regeneration, anomaly logging, and isolation of compromised channels. Such side-channel anomalies are key issues in quantum-secure networking and detecting them protects communication data and key materials from being disclosed or tampered with while in transmission.

As used herein, the term “non-transitory computer-readable storage medium” refers to a tangible storage element containing instructions executable by a processing unit for performing defined computational functions. Said storage medium excludes transitory signals and comprises hardware-based memory structures capable of retaining instructions without continuous power supply. Said storage medium are selected from magnetic, optical, or semiconductor-based and is used to store program code, cryptographic routines, and data handling instructions necessary for secure communication systems. Examples comprise magnetic disks, optical discs, solid-state drives, flash memory, and read-only memory. Instructions stored in the non-transitory computer-readable storage medium direct processors to generate symmetric encryption keys, evaluate trust scores, or transmit encrypted packets across networks. The non-transitory computer-readable storage medium enables portability of secure communication processes and assures persistence of operational logic in distributed environments requiring long-term reliability and reproducibility.

As used herein, the term “computing system” refers to an arrangement of hardware and software resources to execute instructions, process data, and manage communication. The computing system comprises servers, processors, memory, networking interfaces, and storage components operating in coordination. Said computing system executes cryptographic processes, manages distributed ledgers, handles key generation, and controls routing in secure networking environments. Examples of computing systems comprise personal computers running operating systems, enterprise servers hosting applications, virtualised cloud-based clusters, and embedded devices controlling industrial processes. Computing systems are centralised or distributed, physical or virtual, and operate across a wide range of performance levels depending on application requirements. The computing system interacts with communication devices, networks, and storage media to facilitate encrypted data exchange and authentication tasks.

As used herein, the term “processing system” refers to a component focussing on execution of instructions through coordinated operation of processors, memory, and supporting elements. The processing system interprets stored code, perform arithmetic operations, handle input-output interactions, and manage cryptographic tasks associated with secure data transmission. Said processing system may comprise single or multiple processors connected through shared or distributed memory and communication buses. Few examples comprise multicore processor clusters executing parallel tasks, application-specific integrated processing environments, and programmable arrays configured for cryptographic operations. The processing system may also comprise scheduling logic, interrupt handlers, and hardware accelerators for cryptographic functions. The processing system manages encryption, trust evaluation, routing, and blockchain updates in secure networks.

As used herein, the term “communication session” refers to a period during which at least two endpoints exchange communication data utilizing agreed cryptographic keys and parameters. Such a session begins with initiation procedures such as authentication, key generation, or channel establishment and ends with termination events comprising key expiration or timeouts. Said communication session involves transmission of data packets, metadata, and control signals necessary for sustaining a secure exchange. The communication session is selected from secure web browsing sessions, encrypted file transfers, or machine-to-machine transactions within industrial systems. A communication session may be short-lived for individual transactions or persistent for continuous communication. Metadata associated with the session comprises duration, key identifiers, and participating endpoint identities. By defining boundaries of data exchange, the communication session applies encryption, trust evaluation, and ledger recording. Such communication sessions represent the operational context in which cryptographic security and data confidentiality are maintained.

As used herein, the term “key lifecycle event” refers to a state change associated with cryptographic key management throughout its operational existence. Such events comprise key generation, distribution, usage, expiration, rotation, and revocation. Said key lifecycle event is automatically logged in distributed ledgers to provide traceability and accountability in secure systems. Some examples are, creation of symmetric keys using quantum key distribution, expiration of session keys after predefined intervals, or deletion of compromised keys upon detection of anomalies. Key lifecycle events affirm that cryptographic materials are not reused beyond acceptable durations and are regenerated when necessary. Recording of key lifecycle events prevents misuse, supports auditing, and enables recovery in case of any compromise.

As used herein, the term “access policy” refers to a set of defined rules governing how cryptographic materials, communication channels, or stored data are used by entities within a system. The access policy defines roles, permissions, conditions, and restrictions to control secure resource usage. The access policy specifies which devices or users access encryption keys, the duration for which access is granted, and the contexts in which data are transmitted. The access policy is recorded in distributed ledgers alongside key lifecycle events to enforce consistency across nodes. By defining operational boundaries, access policies prevent unauthorised use and reduce exposure to insider or external threats. Such access policies form a vital component of secure networking frameworks.

As used herein, the term “network traffic pattern” refers to characteristics and behaviours of data flow across a communication network. The network traffic pattern comprises metrics such as packet arrival times, bandwidth usage, flow durations, routing sequences, etc. The network traffic pattern is monitored and analysed to detect anomalies, optimise routing, or adjust trust scores. Examples comprise steady traffic in video streaming, burst transmissions in transaction processing, or irregular flows indicating denial-of-service attempts. Network traffic patterns reveal underlying performance issues, security threats, or operational changes in distributed environments. The network traffic patterns provide valuable information for management (adaptive) of secure mesh networking systems.

As used herein, the term “encryption stability” refers to cryptographic process to offer constant operation and resistance to changing compromises. Described stability indicates the way encryption preserves confidentiality and integrity in spite of changes in entropy quality, channel conditions, or computation loads. The encryption stability is influenced by parameters such as key regeneration frequency, signal-to-noise ratio, optical losses, alignment drift, etc. Encryption stability is evaluated through periodic tests, performance metrics, or monitoring of error correction outcomes. Through encryption stability, communication systems enable consistent security during the sessions. Encryption stability is needed to make sure long-term secure transmission over mesh networks immune to classical and quantum-enabled attacks.

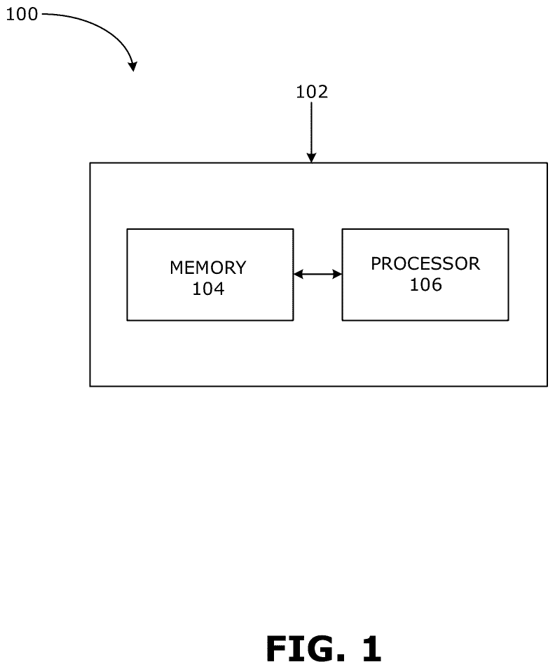

FIG. 1 illustrates an autonomous quantum-secure mesh networking system (100), in accordance with the embodiments of the present disclosure. The autonomous quantum-secure mesh networking system 100 comprises a server 102 which acts as the primary processing and coordination unit for secure communication across distributed nodes. The server 102 is implemented as a physical machine, a cloud-hosted instance, or a virtualized containerized environment depending on deployment requirements. The server 102 comprises communication interfaces for receiving and transmitting data packets over wired or wireless networks, power management circuits, and security components. The server 102 interacts with computing devices that form the endpoints of the communication network and may also interact with intermediate nodes operating in a mesh topology. The server 102 operates autonomously such that routing, key management, and trust evaluation functions are performed without manual intervention. In one aspect, the server 102 is implemented within a data center environment for enterprise use, while in another aspect, the server 102 is implemented in a distributed edge computing environment near endpoint devices.

The server 102 comprises a memory 104 that provides digital storage for instructions, cryptographic material, and operational data necessary for communication (i.e., secure communication). The memory 104 is selected from volatile storage such as dynamic random-access memory used for temporary execution storage, and non-volatile storage such as flash memory, hard drives, or solid-state drives used for persistent storage. In one aspect, the memory 104 stores encryption keys, session metadata, routing parameters, and blockchain ledger entries. The memory 104 may also store software modules for controlling the processor 106 and for enabling trust scoring, entropy validation, and ledger recording. In certain aspect, the memory 104 comprises a hardware secure enclave or trusted platform memory configured to prevent unauthorized extraction of key material. The memory 104 further comprises buffers for packet assembly and disassembly during transmission.

The server 102 also comprises a processor 106 operatively coupled to the memory 104, where the processor 106 executes instructions to control secure communication processes. The processor 106 is selected from a central processing unit, a graphics processing unit, a field programmable gate array, or an application specific integrated circuit. The processor 106 reads instructions from the memory 104 and performs arithmetic and logical operations that perform quantum key generation, trust scoring, and recording using blockchain. In certain exemplary implementation, the processor 106 has dedicated cryptographic accelerators to perform encryption and decryption functions with reduced latency. In other implementations, the processor 106 is arranged as a multi-core unit enabling parallel handling of multiple secure sessions simultaneously. The processor 106 communicates with external computing devices via network interfaces of the server 102 and manages bidirectional flow of communication data. The processor 106 is arranged such that all cryptographic computations remain confined within secure areas of the server 102, thereby preventing unauthorized exposure of sensitive data.

The processor 106 is configured to receive communication data from at least one computing device for secure transmission across a communication network. The computing device is selected from a laptop, smartphone, tablet, sensor, industrial controller, or any other digital unit capable of generating communication data. The communication data comprises text, voice, video, numerical records, or machine instructions. The processor 106 receives communication data through secure communication interfaces that employs Ethernet, Wi-Fi, 5G, or optical fiber connectivity. The communication data arrives in the form of packets that comprise payload data and metadata, which are temporarily buffered in the memory 104 prior to cryptographic processing. In one aspect, the processor 106 classifies incoming data based on type and applies priority rules for encryption and routing. In another aspect, the processor 106 applies compression before encryption to reduce packet size and latency. The processor 106 affirms that received communication data is authenticated, logged, and prepared for secure transmission across untrusted channels.

The processor 106 is further generates a symmetric quantum encryption key using a quantum key distribution process. The quantum key distribution process involves transmission of quantum states (such as photon polarization) through an optical fiber or free-space optical channel. The processor 106 manages photon emission, detection, and reconciliation steps required for establishing a shared symmetric key (with a remote endpoint). Error correction and privacy amplification procedures are also be executed by the processor 106 to refine the key material and eliminate potential information leakage. The generated symmetric quantum encryption key is stored in securely and can be used for encrypting communication data. In one embodiment, the processor 106 regenerates symmetric keys periodically to minimize exposure windows. In another embodiment, the processor 106 validates quantum entropy outputs against randomness thresholds before generating the key.

The processor 106 derives a quantum identity-bound key material by combining the symmetric quantum encryption key with a quantum identity root for authenticating the communication endpoints. The quantum identity root is selected from hardware-based identifiers, biometric templates, device-bound cryptographic credentials or any other uniquely associated identity content with a specific endpoint. The processor 106 integrates such identity attributes with the symmetric quantum encryption key to form session-specific key material that binds encryption functions to verified endpoints. In one aspect, biometric vectors such as iris scans or fingerprint hashes are processed into digital identity roots combined with quantum-generated keys. In another aspect, trusted platform module signatures or hardware security enclave identifiers are used as quantum identity roots. The derived quantum identity-bound key material is stored in the memory 104 and used to authenticate endpoints during session initiation.

The processor 106 is further configured to evaluate a trust score of each available transmission path using a trust model to select a secure transmission path. The trust model considers parameters comprising latency, bandwidth, packet error rate, optical signal quality, entropy sufficiency, and historical reliability of nodes. The processor 106 computes adaptive trust scores by combining real-time measurements with stored trust histories and federated inference results. Transmission paths with trust scores above a threshold are selected for encrypted communication, while paths with low trust scores are excluded (or rerouted). In an exemplary implementation, the trust model incorporates feedback (blockchain-based) from multiple nodes to prevent collusion attacks. In another embodiment, the trust model dynamically re-evaluates trust scores during an active session to detect changes in reliability. The trust score evaluation process affirms that communication data traverses only through paths with acceptable reliability and security. The processor 106 stores trust scores in the memory 104 for auditing and analysis.

The processor 106 is further configured to encrypt communication data and associated session metadata using the symmetric quantum encryption key. Session metadata comprises details such as session identifiers, participating endpoint addresses, timestamps, and key identifiers. The processor 106 applies symmetric encryption to both payload data and metadata, thereby preventing leakage of contextual information. In one embodiment, the processor 106 uses the Advanced Encryption Standard algorithm in conjunction with the symmetric quantum encryption key. In another embodiment, the processor 106 uses one-time pad encryption seeded by quantum-generated randomness. The encryption process is performed within a secure enclave of the processor 106 to prevent exposure of unencrypted data.

The processor 106 is further configured to record an identifier of each encrypted packet and at least one trust-related parameter of the secure transmission path on a blockchain-based distributed ledger. The blockchain-based ledger is private, consortium, or hybrid depending on system deployment. The processor 106 generates entries that comprise cryptographic hashes of encrypted packets, associated trust scores, transmission path identifiers, and temporal anchors. Said entries are added to the ledger and replicated across involved nodes for distributed storage. In a first embodiment, the ledger entry contains entropy fingerprints generated during key generation to attest to origin authenticity. In a second embodiment, the ledger entry contains device identity characteristics with respect to endpoints. By recording such information on an immutable ledger, the system 100 provides verifiable evidence of communication events. The memory 104 stores a local copy of the ledger for immediate access, while full copies are stored across distributed network nodes to provide tamper resistance and auditability.

The processor 106 forwards the encrypted communication data along the selected secure transmission path. After encryption and ledger recording processes are done, the encrypted packets are compiled into transmission headers and forwarded over path selected based on trust scores. Transmission occurs over optical fiber links, wireless mesh channels, or satellite-assisted paths depending on availability. The processor 106 manages retransmissions in case of packet loss, applies error correction codes, and monitors acknowledgement messages to confirm delivery. In one embodiment, the processor 106 reroutes encrypted packets dynamically if trust scores of the active path decline. In another embodiment, the processor 106 creates a virtualized quantum key distribution tunnel for transporting both entropy packets and encrypted data. The memory 104 logs transmission events for post-session auditing and verification of secure delivery.

In an embodiment, the autonomous quantum-secure mesh networking system 100 may derive identity-bound key material by combining a symmetric quantum encryption key with a quantum identity root that incorporates either multimodal biometric vectors or hardware signatures. The processor 106 receives the symmetric quantum encryption key generated through a quantum key distribution process and securely integrates said process with biometric inputs such as fingerprint hashes, facial recognition vectors, or iris scan templates. Alternatively, the processor 106 integrates hardware-based identifiers comprising motherboard serial codes, trusted platform module signatures, or cryptographic secure enclave identifiers. For example, when a user endpoint device transmits a biometric vector corresponding to a facial recognition scan represented by a 512-dimensional embedding, the processor 106 combines such vector with a 256-bit symmetric quantum encryption key to generate a composite quantum identity-bound key material of 768 bits. The resulting key material is stored securely in memory 104 and is used to authenticate endpoints prior to initiating communication.

In an embodiment, the autonomous quantum-secure mesh networking system 100 may employ a trust model that computes adaptive trust scores using a federated inference model, influencing both routing preferences and encryption policies during secure transmission. The processor 106 gathers trust-related parameters from multiple nodes comprising latency, packet delivery ratios, historical reliability, and error rates, and applies distributed learning techniques without aggregating raw data centrally. Each participating node contributes model updates that are combined into a global trust model, thereby avoiding privacy leakage (and maintaining accuracy). The adaptive trust score is recalculated dynamically in response to new data, affirming resilience against changing network conditions. For instance, if a transmission route demonstrates rising packet loss past 2% as latency increases more than 100 milliseconds, federated trust diminishes the path score by 0.35 on a standardized scale of 0 to 1, tilting favor toward other routes. Encryption policies are also influenced, with higher-scored paths receiving stricter session key refresh intervals and extended authentication requirements.

In an embodiment, the autonomous quantum-secure mesh networking system 100 may apply a metadata encryption process that utilises the symmetric quantum encryption key, at least one quantum entropy-derived parameter, and at least one trust score parameter for securing both communication data and session metadata stored in memory 104. The processor 106 generates session metadata comprising identifiers of endpoints, timestamps, routing details, and cryptographic seed references, and applies an additional encryption layer before storage/transmission. The symmetric quantum encryption key forms the basis of encryption, while quantum entropy-derived parameters serve as nonces for introducing randomness. Trust score parameters influence key rotation frequency and metadata encryption strength. For example, if a session trust score is calculated as 0.8 on a normalized scale, the processor 106 encrypts metadata using AES-256 with entropy-based initialization vectors refreshed every 200 milliseconds. Conversely, if the trust score drops to 0.5, metadata encryption is upgraded with additional entropy-based keys refreshed every 50 milliseconds.

In an embodiment, the autonomous quantum-secure mesh networking system 100 may record cryptographic lifecycle events and access policies related to symmetric quantum encryption keys on a blockchain-based distributed ledger. The processor 106 generates ledger entries for events comprising key generation, usage initiation, scheduled expiration, regeneration, and revocation. Each event entry is timestamped and hashed (cryptographically) before being appended to the blockchain ledger for immutability and transparency. Access policies associated with each symmetric quantum encryption key are likewise recorded, defining which devices or endpoints are authorized to access the keys, under what conditions, and for what duration. For example, when a key is generated with a lifetime of 30 minutes and restricted for use by endpoint device A and server 102, such parameters are encoded into the ledger entry along with a SHA-256 hash of the key identifier. Subsequent attempts by unauthorized endpoints to access the key are denied by ledger verification. The blockchain-based ledger provides traceable accountability of key usage, thereby enabling auditing and forensic validation of all cryptographic events within the system 100.

In an embodiment, the autonomous quantum-secure mesh networking system 100 may receive entropy values generated by a quantum random number generator, which are subsequently transformed into a cryptographic seed used for generating the symmetric quantum encryption key. The processor 106 receives bitstreams from the quantum random number generator that may be based on quantum optical processes such as photon detection timing or phase noise. The raw entropy values are tested for randomness quality using statistical methods before transformation. Upon validation, the entropy values are compressed or hashed into a cryptographic seed (fixed length), for example, a 512-bit seed derived from an original entropy pool of 4096 bits. The processor 106 then applies the cryptographic seed to a key derivation function that generates the symmetric quantum encryption key.

In an embodiment, the autonomous quantum-secure mesh networking system 100 can check entropy values received from the quantum random number generator prior to converting said values into cryptographic seeds. Processor 106 checks received entropy parameters against predetermined thresholds for randomness, bias, and uniformity. Such checks comprise running statistical tests such as frequency tests, runs tests, and autocorrelation tests to identify anomalies or vulnerabilities. When entropy parameters don't satisfy thresholds, the processor 106 causes regeneration of entropy in the quantum identity root. For example, if a batch of 4096 entropy bits demonstrates bias exceeding 2% in bit distribution, the entropy is rejected, and the generator is re-seeded with alternative quantum events. The regenerated entropy is then validated again until acceptable randomness levels are achieved.

In another embodiment, the autonomous quantum-secure mesh networking system 100 may keep check of entropy fingerprints originating from authenticated entropy values within blockchain-based distributed ledger, temporal event anchors, device identity attributes, etc. The processor 106 derives entropy fingerprints by applying cryptographic hash functions to validated entropy outputs, generating identifiers that uniquely characterize the entropy used in seed generation. Temporal event anchors including generation timestamps are added, along with device identity attributes such as hardware identifiers or secure enclave codes. For example, when an entropy batch of 4096 bits is hashed into a 256-bit fingerprint, the fingerprint is stored with a generation timestamp of 12:01:35 UTC and a server hardware signature. Such a ledger entry allows future verification that a specific cryptographic seed originated from a trusted device at a verifiable time. By appending entropy fingerprints, temporal anchors, and identity attributes to the ledger, the system 100 establishes auditability and origin authenticity for symmetric quantum encryption keys.

In an embodiment, the autonomous quantum-secure mesh networking system 100 may control the quantum key distribution process to transmit photons across an optical fiber medium, detects eavesdropping attempts by evaluating quantum bit error rate, and terminates key generation if thresholds are exceeded. The processor 106 manages photon emission and detection equipment to send encoded qubits through the optical fiber. During reconciliation, subsets of transmitted and received qubits are compared, and the error rate is calculated. For example, if 1000 qubits are exchanged and 85 discrepancies are observed, the quantum bit error rate is measured at around 8.5%, within acceptable limits (for generation of key). If the error rate exceeds a predefined threshold, (i.e., 11-12%), the processor 106 aborts the key exchange and discards the partially generated key.

In an embodiment, the autonomous quantum-secure mesh networking system 100 may coordinate endpoint-local generation of symmetric quantum encryption keys, such that the keys are created within both the server 102 and the computing device without transmission across the network. The processor 106 manages synchronized entropy sampling or deterministic seed expansion such that both endpoints independently generate identical symmetric keys. For example, the server 102 and a client device may each receive a 512-bit entropy batch from respective local quantum random number generators, validated and processed through identical key derivation functions. The outputs are mathematically identical symmetric keys without requiring network exchange. The processor 106 coordinates timing signals and seed alignment to assure consistency. The system 100 eliminates exposure of sensitive cryptographic data (by avoiding transmission of the key material) to adversaries monitoring the network. Endpoint-local generation strengthens confidentiality and integrity, enabling secure communication sessions between trusted devices without requiring key transport over untrusted paths.

In an embodiment, the autonomous quantum-secure mesh networking system 100 may check the adequacy of entropy during the quantum key distribution process by taking samples of quantum entropy outputs and starting regeneration events when the levels of entropy drop below thresholds. The processor 106 periodically samples entropy streams generated during qubit transmission, applying statistical analyses to measure uniformity, unpredictability, and variance. If entropy output levels are insufficient, the processor 106 instructs the quantum source to regenerate entropy using alternative physical processes or extended measurement intervals. For example, if an entropy batch of 2048 bits demonstrates variance lower than 0.8 on a normalized scale of 0 to 1, the batch is deemed insufficient and regenerated. The validated entropy is then used for key derivation to prevent weak cryptographic materials.

In an embodiment, the autonomous quantum-secure mesh networking system 100 can improve the quantum key distribution process by choosing photon-based transmission paths for measured quality factors so as to reduce latency and maintain encryption stability. The processor 106 evaluates multiple candidate paths by monitoring metrics including signal-to-noise ratio, optical loss, alignment drift, bit error rate, temperature fluctuations, vibration levels, photon transmission metrics, network traffic patterns, and network latency. Each parameter is weighted within a path scoring model to determine the most suitable route. For instance, if Path A shows signal-to-noise ratio of 25 decibels, optical loss of 0.2 dB/km, and average latency of 5 milliseconds, whereas Path B shows 20 decibels, 0.5 dB/km, and 15 milliseconds, the processor 106 will score Path A higher and choose it. Optimization is also done dynamically, with routes re-calculated during active sessions to help assure stability.

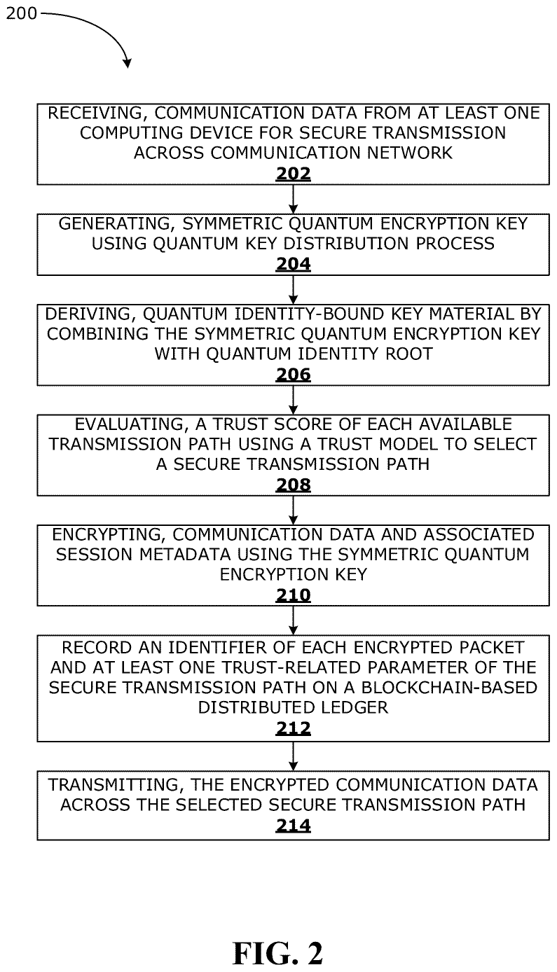

FIG. 2 illustrates a method (200) for securely transmitting communication data over a quantum-secure mesh network, in accordance with the embodiments of the present disclosure. At step 202, the processor 106 of the server 102 receives communication data from at least one computing device for secure transmission across a communication network. The communication data may comprise textual information, control commands, financial transaction packets, or sensor telemetry. The processor 106 receives the data via wired, wireless, or optical interfaces and stores the incoming packets in safe areas of the memory 104 temporarily. Each packet can be tagged with metadata including the source device description, timestamp, and session identifier. The 106 processor checks formatting affirms the integrity of communications and formats the data for future cryptographic processing.

At step 204, the processor 106 generates a symmetric quantum encryption key using a quantum key distribution process. The processor 106 controls emission and detection components that exchange quantum states such as photons over an optical fiber or free-space optical link between the server 102 and a remote endpoint. The processor 106 applies reconciliation, error correction, and privacy amplification to produce a shared symmetric key whose randomness originates from quantum phenomena. For example, when 1024 photon exchanges produce a validated quantum bit error rate below a defined threshold such as 10 percent, a 256-bit symmetric quantum encryption key is confirmed and stored within a secure enclave of the memory 104.

At step 206, the processor 106 derives quantum identity-bound key material by combining the symmetric quantum encryption key with a quantum identity root for authenticating the communication endpoints. The quantum identity root can comprise biometric data, including fingerprint or iris pattern information, or a hardware signature tied to a trusted device component. The processor 106 executes a key derivation operation that combines both elements, generating a composite credential that is bound exclusively to the endpoint's identity. The resulting quantum identity-bound key material is written to the memory 104 and referenced for verification during session establishment.

At step 208, the processor 106 assesses a trust score for every available transmission path through the use of a trust model to choose a secure transmission path. The trust model considers parameters including latency, packet loss, bandwidth, optical attenuation, and historical reliability metrics gathered from network nodes. The processor 106 computes numerical trust scores for all available paths and records them in the memory 104. Paths with trust scores below a predetermined limit are excluded from use. The processor 106 selects the path with the highest verified trust score as the secure route for encrypted transmission and enables alternates for redundancy.

At step 210, the processor 106 encrypts the communication data and associated session metadata using the symmetric quantum encryption key. The payloads stored in the memory 104 are combined with metadata that may comprise session identifiers, endpoint references, and timing information. The processor 106 applies symmetric encryption, such as authenticated block-cipher operations, to produce ciphertext and integrity verification tags. Encryption transforms readable data into a secure form that cannot be deciphered without possession of the same symmetric quantum key. The resulting encrypted packets are queued in the memory 104 for recording and transmission.

At step 212, the processor 106 records an identifier of each encrypted packet and at least one trust-related parameter of the secure transmission path on a blockchain-based distributed ledger. The processor 106 computes a cryptographic hash of each encrypted packet or assigns a unique identifier linked to its encryption session. Each identifier is associated with the current trust score, transmission path reference, and a timestamp, which are bundled into a ledger transaction. The transaction is appended to a distributed ledger accessible to authorized network participants. A transaction acknowledgment is stored locally in the memory 104 for confirmation.

At step 214, the processor 106 transmits the encrypted communication data across the selected secure transmission path. The processor 106 encapsulates the encrypted packets into transport frames, applies necessary fragmentation or forward-error correction, and dispatches the frames to the next network node or destination endpoint. Delivery confirmations and acknowledgments are tracked, and retransmission is done if failures are indicated. The processor 106 dynamically recalculates the trust rating while in transit and can redirect packets along alternative routes if the conditions worsen.

In an embodiment, the method 200 may expire a generated symmetric quantum encryption key after a predefined session duration and regenerates a fresh symmetric quantum encryption key for any remaining session interval. The processor 106 maintains a key schedule in the memory 104 that comprises a start timestamp, a lifetime parameter, and a renewal offset. For instance, an active session might be assigned a total of 60 minutes with a primary lifetime of 15 minutes and a renewal offset of 10 seconds. At t=900 seconds, the processor 106 marks the active key as expiring, initiates a quantum key distribution procedure, and installs a newly generated 256-bit key before the expiry instant to prevent gaps. Outbound encryption switches to the new key at a sequence boundary, while inbound acceptance has a dual-key grace window of 250 milliseconds to finish in-flight packet processing. The processor 106 zeroizes the retired key material in specified secure areas of the memory 104 and logs a key lifecycle event on a distributed ledger. Rekey events are iterated until the session is ended, thus assuring confidentiality for the entire remaining duration of the session without reusing outdated keys.

In an embodiment, the method 200 may configure a direct quantum key distribution channel between two endpoints of the communication network to bypass intermediate routing infrastructure. The processor 106 negotiates a control association with a peer device and allocates a quantum channel using an optical interface on the server 102, reserving a dedicated wavelength, for example 1550 nm, to carry quantum states. A classical authenticated link is maintained in parallel for sifting, error correction, and privacy amplification signalling, while no intermediate routers are permitted to mediate the quantum path. For a 20 km single-mode fiber run, a sifted key rate of approximately 50 kbps may be achieved with a quantum bit error rate stabilized below 5%. The processor 106 stores channel parameters, detector calibration, polarization or phase alignment settings, and decoy-state schedules in the memory 104, and continuously monitors attenuation and dark count statistics. By establishing a point-to-point optical path with no transit devices, exposure of raw quantum states to third-party infrastructure is avoided, thereby reducing attack surface while providing a stable high-fidelity medium for symmetric key establishment.

In an embodiment, the method 200 may dynamically reroute encrypted communication data through an alternative transmission path when an evaluated trust score falls below a preset criterion. The processor 106 computes path trust values using latency, loss, signal-to-noise ratio, anomaly reports, and historical consistency, persisting per-path scores in the memory 104. A policy threshold, for example 0.65 on a 0-1 scale, is enforced with hysteresis to prevent oscillation. If an active path score declines to 0.52 for three consecutive windows of 500 milliseconds, the processor 106 suspends further dispatch on the degraded route, flushes unsent ciphertext to a standby queue, and selects a candidate route with a higher trust score, for example 0.83. Nonces and sequence counters are advanced to maintain uniqueness, and integrity associations are rebound without changing the symmetric quantum encryption key unless a concurrent rekey policy is triggered. Ledger entries record the path change, the measured scores, and timestamps. Buffered packets are transmitted on the alternative path with forward error correction parameters recalculated for the new medium.

In an embodiment, the method 200 may configure a virtualized quantum key distribution tunnel between two endpoints to carry session quantum entropy packets and encrypted communication data based on the evaluated trust score and channel availability. The processor 106 provisions a logical overlay using a software-defined networking control plane, assigns a tunnel identifier, and applies isolation policies in the memory 104. When the trust score exceeds a high-integrity threshold, for example 0.80, the tunnel is permitted to multiplex both quantum entropy packets used for seeding or reconciliation and ciphertext payloads, with bandwidth reservations, for example 5 Mbps for ciphertext and 200 kbps for entropy signalling. When the trust score drops into a caution range, for example 0.60-0.79, the processor 106 restricts the tunnel to entropy packets only and migrates ciphertext to a separately scored transport. Channel availability is polled at 100 millisecond intervals, and tunnelling decisions are re-evaluated accordingly. Encapsulation formats comprise authenticated headers with tunnel keys bound to the session context stored in the memory 104. Path metrics and tunnel health indicators are reported to a policy engine to sustain throughput, isolation, and auditability across the mesh.

In an embodiment, the method 200 may detect a side-channel anomaly selected from photon blinding attempts, timing discrepancies, and entropy drift, and regenerates the symmetric quantum encryption key in response. The processor 106 samples detector current and count rates to identify saturation patterns consistent with blinding, for example sustained counts above 10× baseline for more than 5 milliseconds. Timing discrepancies are flagged when inter-arrival distributions deviate beyond three standard deviations from calibrated profiles over a 1,000-event window. Entropy drift is detected when NIST SP 800-22 tests fail on recent quantum random batches written to the memory 104. Upon detection, the processor 106 discards partially derived material, and starts a new quantum exchange with rescaled optical power and randomized decoy schedules. A fresh 256-bit symmetric key is created, old key material is zeroed, and ledger records note anomaly type, metrics, and remediation timestamps. Packet transmission resumes only after successful authentication using the regenerated key, thereby restoring cryptographic assurances following the side-channel event.

In an embodiment, a non-transitory computer-readable storage medium stores executable instructions which, when executed by a processing system including the processor 106, facilitate secure transmission of communication data over a quantum-secure mesh network. The instructions cause the server 102 with the memory 104 to receive communication data from at least one computing device, generate a symmetric quantum encryption key using a quantum key distribution process, derive quantum identity-bound key material by combining the symmetric key with a quantum identity root, evaluate a trust score for available transmission paths using a trust model, encrypt communication data and associated session metadata with the symmetric key, record an identifier of each encrypted packet with at least one trust-related parameter on a blockchain-based distributed ledger, and transmit encrypted communication data across a selected secure transmission path. Code sections comprise a receiver pipeline, a quantum key manager, an identity binder, a trust engine, an authenticated-encryption module, a ledger client, and a dispatcher, each maintaining state in the memory 104. In one example embodiment, the instruction image occupies 48 MB, with cryptographic tables provisioned at runtime.

In an embodiment, server 102 comprising memory 104 and processor 106 gains low communication latency through localized cryptographic processes in a tightly coupled design. Processor 106 accepts communication data to provide uninterrupted ingestion of data, reducing delays in secure message passage. Generation of symmetric quantum encryption keys by the processor 106 enhances confidentiality since such keys are derived from quantum mechanics and resist brute force or quantum computational attacks. Derivation of quantum identity-bound key material affirms endpoint authentication, thereby reducing impersonation risks. Evaluation of trust scores by processor 106 optimizes routing by dynamically excluding compromised or unstable paths, thereby improving network resilience. Encryption of both communication data and metadata prevents disclosure of contextual details that adversaries could exploit, thereby protecting privacy. Recording identifiers and trust parameters on a blockchain-based distributed ledger affirms tamper-resistant auditing and forensic traceability. Transmission across the selected secure path increases reliability since routing is bound to continuously validated trust scores.

In an embodiment, combining a symmetric quantum encryption key with a quantum identity root and multimodal biometric vectors make sure that cryptographic materials are tied uniquely to human users, reducing risks of stolen credentials being reused. Integration with biometric vectors like, iris patterns, fingerprint hashes, or voice recognition templates provides multi-layer verification. Use of hardware signatures as inputs creates hardware-bound credentials, preventing cloning attacks on software-only identities. The system thereby improves endpoint-specific authentication robustness and reduces man-in-the-middle opportunities. Identity binding with quantum-derived keys provides session-specific, non-replicable key material that becomes useless if intercepted outside the intended device.

In an embodiment, computing an adaptive trust score through a federated inference model reduces reliance on central data collection, thereby protecting privacy while still improving routing accuracy. The federated model facilitates distributed learning among nodes, enhancing the accuracy of trust scoring. Dynamic scoring re-computes trust according to current conditions, avoiding the use of impaired or compromised routes over time. Routing preferences influenced by trust scores reduce packet losses and retransmissions (increasing throughput). Encryption policies linked to trust scores allow higher frequency key rotations for low-trust paths, thereby reducing compromise risks.

In an embodiment, employing quantum entropy-based parameters in metadata encryption makes initialization vectors and nonces unpredictable and thus provides enhanced encryption. Coupling metadata encryption with trust score parameters make it possible to have flexible encryption strength that adjusts based on network risk. Keeping encrypted metadata in memory 104 avoids leakage of communication patterns accessible to attackers. Encrypting both payloads and metadata creates uniform ciphertext streams, thus preventing traffic analysis attacks.

In an embodiment, recording key lifecycle events on a blockchain-based distributed ledger makes sure that key generation, usage, and expiration are immutable and auditable. Recording access policies forges protection against unauthorized parties' efforts to try key retrieval without being noticed. Tamper resistance of blockchain technology affirms integrity of security records across distributed nodes. Store-recorded access policies assure cryptographically enforceable rules with verifiable governance within disparate systems. Recording lifecycle transitions reduces reuse of expired keys and enforces on time regeneration. The distributed ledger mechanism increases accountability of endpoints and provides forensic capabilities during investigations of breach.

In an embodiment, receiving entropy values from a quantum random number generator affirms that generated cryptographic seeds are unpredictable and resistant to modelling attacks. Transformation of entropy into seeds standardizes randomness into fixed-length materials suitable for key derivation. The randomness reduces vulnerability to biased or insufficiently random sources. Holding entropy values in memory 104 prior to seed conversion for authentication enhances resilience against erroneous entropy sources. By using quantum effects like the timing of photon detection or tunnelling processes, entropy values are higher than levels of unpredictability by classical pseudo-random generators.

In an embodiment, validating entropy values against predefined thresholds makes sure that weak randomness is not used in seed generation. Comparing against expected statistical baselines allows rejection of biased or correlated entropy samples. Regeneration within the quantum identity root maintains continuity of secure entropy without exposing key materials externally. Detection of mismatches enables immediate replacement of entropy, preventing key degradation. Validation makes sure adherence to cryptographic strength standards, reducing risks of substandard key generation. By continuously verifying entropy sufficiency, the processor 106 provides resilience against manipulation of entropy sources.

In an embodiment, recording entropy fingerprints on a blockchain-based distributed ledger assures traceability of entropy origin, thereby enabling auditability. Linking fingerprints with temporal anchors provides chronological proof of entropy usage. Recording device identity attributes ties entropy generation to specific hardware endpoints, preventing replay or forgery. Immutable ledger entries make sure that no entropy record can be modified or deleted after insertion. Entropy fingerprint storage enables independent verification of key origins during post-event investigations. Such recording mechanisms improve transparency and provide non-repudiation for entropy-based cryptographic operations.

In an embodiment, controlling quantum key distribution over an optical fiber medium affirms stable photon transmission across long distances with reduced attenuation. Monitoring quantum bit error rates provides real-time detection of eavesdropping attempts, since interception alters photon states. Terminating key generation when error thresholds exceed limits prevents use of compromised keys. Use of optical fiber makes sure compatibility with existing network infrastructure while enabling quantum-secure links. Evaluating photon transmission quality improves selection of viable fiber paths, reducing retransmission overhead. Such control improves resilience of key exchanges in hostile or noisy environments.

In an embodiment, coordinating endpoint-local key generation prevents key material from being exchanged over potentially insecure networks. Both server 102 and computing devices generate identical symmetric keys independently, reducing interception risks. Local entropy sources affirm that each endpoint contributes randomness while remaining synchronized through processor 106 coordination. Local entropy sources eliminate transport vulnerabilities inherent to distributed key delivery. Retention of keys within device boundaries improves resistance to insider attacks targeting transmission channels. Such endpoint-local generation improves confidentiality by ensuring that no symmetric key leaves the originating hardware.

In an embodiment, verifying entropy sufficiency during key distribution assures that inadequate randomness prevents compromise of key strength. Sampling quantum entropy output enables continuous quality checks. Initiating regeneration events prevents continuation of sessions using weak entropy. Real-time verification makes sure adherence to entropy thresholds, thereby aligning with cryptographic compliance standards. Continuous entropy monitoring assures resilience to hardware drift or degradation of entropy sources. Such validation increases robustness of quantum key distribution via strong entropy which contributes to final symmetric key generation.

In an embodiment, optimizing quantum key distribution by selecting photon-based transmission paths based on measured metrics reduces overall latency. Considering signal-to-noise ratio assures stronger photon detection accuracy. Evaluating optical loss allows avoidance of degraded channels, thereby improving key exchange stability. Monitoring alignment drift reduces error rates due to physical fiber displacement. Including temperature fluctuation and vibration levels accounts for environmental impacts on photon fidelity. Assessing network traffic patterns reduces congestion-related delays.

In an embodiment, performing secure transmission using a server 102 with processor 106 and memory 104 affirms centralized control of cryptographic operations while maintaining distributed routing flexibility. Receiving communication data makes sure orderly intake of messages prior to encryption. Generating symmetric quantum encryption keys strengthens confidentiality against quantum-enabled adversaries. Deriving quantum identity-bound keys provides endpoint authentication resistant to spoofing. Trust score evaluation enables dynamic path selection, increasing reliability. Encrypting payloads and metadata protects confidentiality and prevents traffic analysis. Recording identifiers on blockchain ledgers provides non-repudiation.

In an embodiment, expiring symmetric keys after predefined session durations reduces exposure windows, thereby compromised keys cannot be reused beyond allowed intervals. Regenerating fresh keys for remaining sessions maintains uninterrupted security without requiring session termination. Scheduled expiration assures compliance with cryptographic best practices regarding key lifetimes. Automatic regeneration reduces operational overhead for administrators. Frequent rekeying enables session confidentiality even if partial information leaks occur. Such lifecycle control provides balance between security and continuity.

In an embodiment, configuring a direct quantum key distribution channel bypasses intermediate routing infrastructure, thereby reducing exposure of quantum states to adversaries. Establishing direct optical links between endpoints reduces photon loss and interference. Direct paths reduce error rates since fewer nodes introduce noise. Removing intermediate infrastructure prevents tampering during key exchange. Such direct channels improve key generation rate stability and reduce detection latency for eavesdropping attempts.

In an embodiment, dynamically rerouting encrypted communication data when trust scores fall below thresholds prevents persistent use of insecure paths. Switching to higher-trust alternatives maintains delivery without session interruption. Rerouting reduces packet losses and minimizes retransmission delays. Dynamic adaptation prevents exploitation of degraded paths by malicious nodes. Such rerouting improves resilience of secure communication in rapidly changing environments.

In an embodiment, configuring a virtualized quantum key distribution tunnel enables simultaneous transmission of quantum entropy packets and encrypted payloads within isolated overlays. Such tunnelling reduces congestion by reserving logical paths for session-specific data. Trust score-driven allocation ensures that sensitive entropy packets traverse only secure paths. Virtualization allows multiple sessions to coexist without interference. Such tunnels improve efficiency while maintaining secure partitioning of resources.

In an embodiment, detecting side-channel anomalies such as photon blinding attempts terminates compromised sessions, before exploitation. Monitoring timing discrepancies detects delays introduced by malicious manipulation. Identifying entropy drift prevents usage of degraded randomness. Regenerating symmetric keys restores session integrity after anomalies. Such detection and regeneration maintain system resilience even under active attack conditions.

In an embodiment, implementing a non-transitory computer-readable storage medium with executable instructions provides reproducibility of secure operations across hardware environments. The instructions enable receiving data, generating quantum-secure keys, deriving identity-bound material, evaluating trust scores, encrypting payloads, recording blockchain ledger entries, and transmitting packets. Storage on such a medium allows persistence, enabling rapid deployment across distributed systems. The reproducibility of functions enables uniform application of cryptographic policies across heterogeneous nodes.

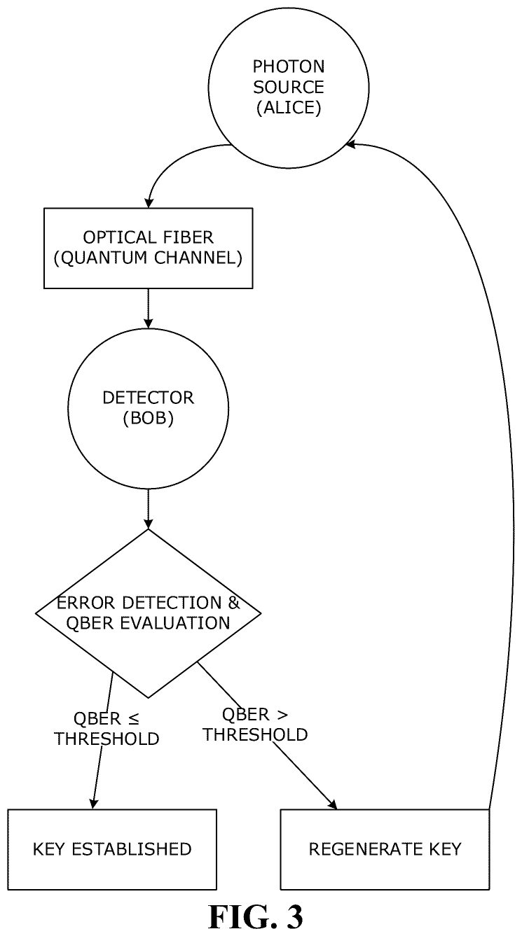

FIG. 3 illustrates a process flow for quantum key establishment using a quantum key distribution (QKD) mechanism, in accordance with the embodiments of the present disclosure. A photon source associated with Alice generates a sequence of photons which are transmitted through an optical fiber functioning as a quantum channel. The photons transmitted through the quantum channel are received by a detector associated with Bob. The detector performs measurements on the received photons based on predetermined quantum states for generation of a raw key. Subsequent to the detection process, an error detection and quantum bit error rate (QBER) evaluation are performed to determine the integrity of the received key. When the QBER is less than or equal to a predefined threshold, the key is considered secure, and a final secret key is established between Alice and Bob. When the QBER exceeds the threshold, the key is regarded as compromised and a key regeneration process is initiated wherein a new sequence of photons is generated by the photon source associated with Alice and retransmitted through the quantum channel. Such a cyclic process of QBER evaluation and key regeneration enables the establishment of an error-free and secure cryptographic key for quantum communication between Alice and Bob.

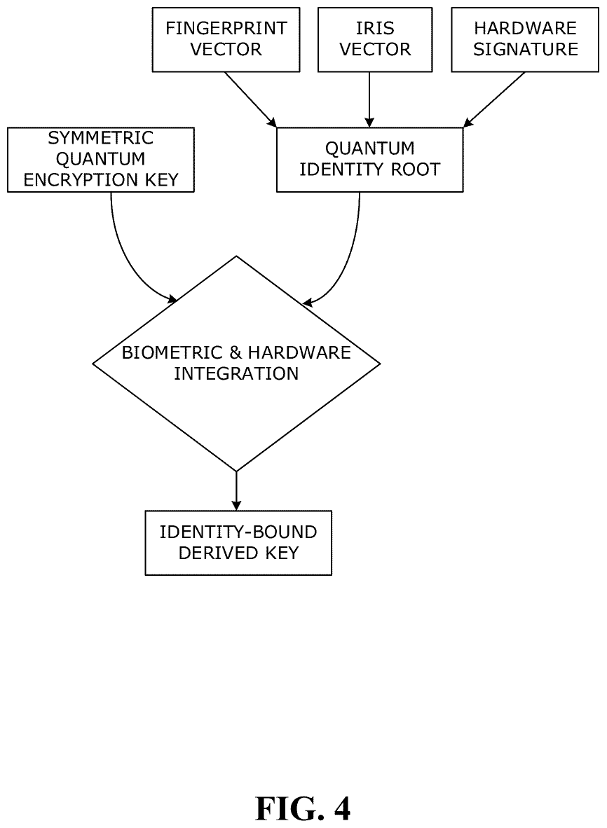

FIG. 4 illustrates a process for generating an identity-bound derived key using biometric and hardware integration, in accordance with the embodiments of the present disclosure. A fingerprint vector, an iris vector, and a hardware signature are obtained as unique identifiers corresponding to an individual and a device. Such biometric and hardware parameters are processed to generate a quantum identity root that serves as a foundational reference for secure identity establishment. A symmetric quantum encryption key is generated independently and is provided along with the quantum identity root to a biometric and hardware integration module. The biometric and hardware integration module performs correlation and binding operations between the quantum identity root and the symmetric quantum encryption key by using the biometric and hardware characteristics. The integration process results in the derivation of an identity-bound key that is cryptographically linked to both the biometric attributes of the user and the hardware features of the associated device. The identity-bound derived key ensures that the encryption key cannot be replicated, transferred, or utilized on unauthorized hardware, thereby enhancing authentication robustness and preventing impersonation. Such integration of quantum encryption with biometric and hardware parameters enables secure identity verification and key generation in quantum-secured communication environments.

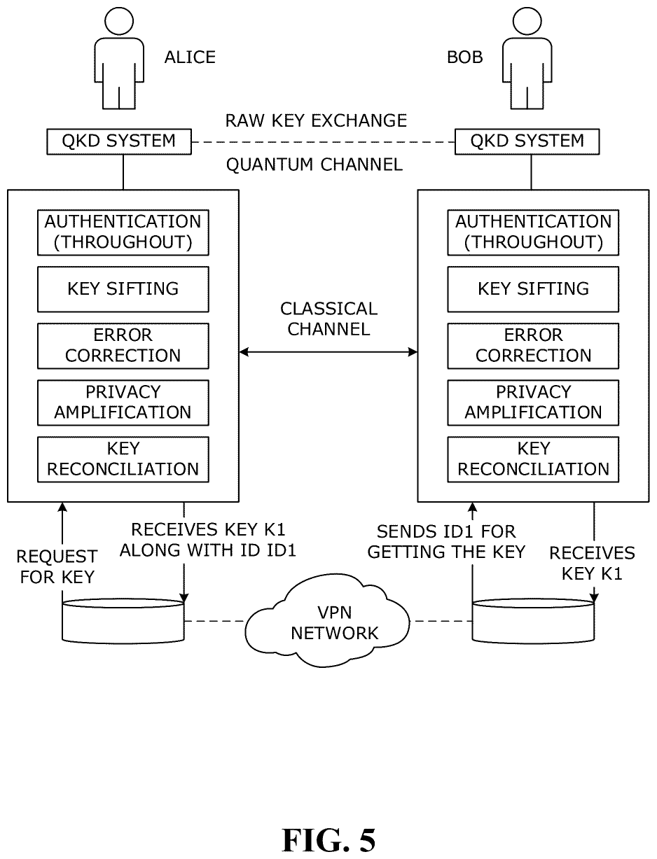

FIG. 5 illustrates a quantum key distribution (QKD) based secure key exchange architecture between two communicating entities, Alice and Bob, in accordance with the embodiments of the present disclosure. The architecture comprises QKD systems associated respectively with Alice and Bob, which communicate through a quantum channel for performing raw key exchange. The raw quantum keys transmitted through the quantum channel undergo a sequence of classical post-processing operations that comprise authentication performed throughout the process, key sifting, error correction, privacy amplification, and key reconciliation. Such post-processing operations are performed through a classical channel that enables the exchange of auxiliary information necessary for error detection and privacy preservation. A virtual private network (VPN) network forms part of the classical communication channel and manages key requests and deliveries. A request for a key is initiated by Alice, and upon successful authentication and post-processing, a quantum-derived key K1 along with an associated identification ID1 is generated and received by Alice. Bob transmits the ID1 through the VPN network for retrieval of the corresponding key K1 and subsequently receives the same key.

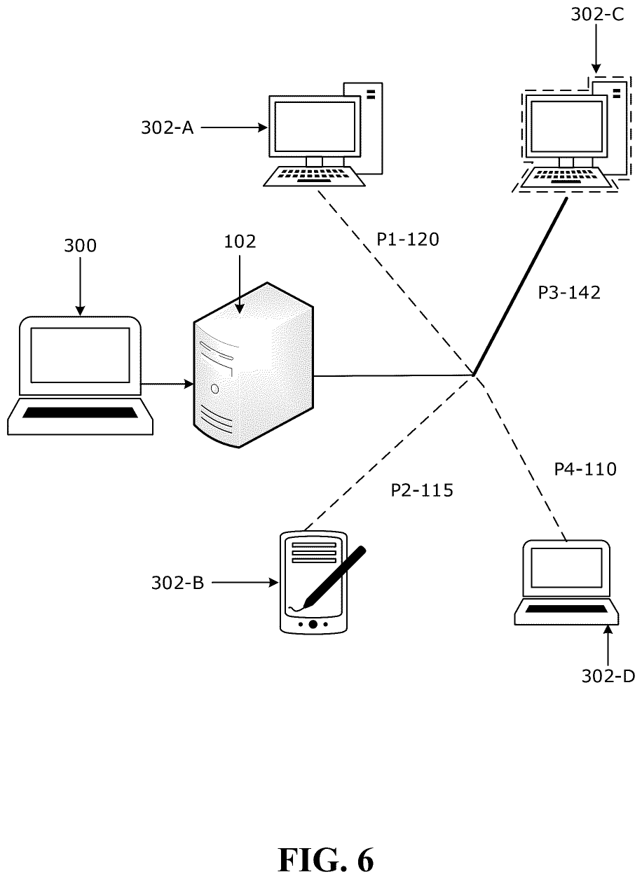

FIG. 6 illustrates a system architecture for autonomous selection of a secure transmission path based on dynamic trust evaluation, in accordance with the embodiments of the present disclosure. A computing device 300 is shown transmitting communication data to a server 102 positioned centrally within a network environment. The server 102 comprises a processor and a memory configured for performing trust assessment and routing control of received communication data. The processor evaluates a plurality of available transmission paths, denoted as path P1, path P2, path P3 and path P4, which are respectively connected to computing nodes 302-A, 302-B, 302-C and 302-D. Each of the transmission paths is assigned a corresponding trust score determined on the basis of measurable network parameters such as node integrity, communication latency, link stability, and authentication strength. The respective trust scores associated with the paths are 120 for path P1, 115 for path P2, 142 for path P3 and 110 for path P4. Upon evaluation, the processor identifies path P3 having the highest trust score i.e., 142 as the most reliable and secure communication route for transmission of encrypted communication data towards destination node 302-C. Said path P3 is represented by a bold line to indicate the selected transmission channel, while paths P1, P2 and P4 are illustrated as dashed lines indicating lower trust-score alternatives that remain unselected for the given transmission session. Such an autonomous selection of a communication path based on computed trust scores enables enhanced confidentiality, authenticity and reliability of data transmission across the communication network.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ comprises, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings are/are used. Those skilled in art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is comprised within the scope of the present disclosure.

I/We claim:

1. An autonomous quantum-secure mesh networking system (100) comprising:
a server (102) comprising:
a memory (104); and
a processor (106) operatively coupled to the memory (104), the processor (106) configured to:
receive communication data from at least one computing device for secure transmission across a communication network;
generate a symmetric quantum encryption key using a quantum key distribution process;
derive a quantum identity-bound key material by combining the symmetric quantum encryption key with a quantum identity root for authenticating the communication endpoints;
evaluate a trust score of each available transmission path using a trust model to select a secure transmission path;
encrypt communication data and associated session metadata using the symmetric quantum encryption key;
record an identifier of each encrypted packet and at least one trust-related parameter of the secure transmission path on a blockchain-based distributed ledger; and
transmit the encrypted communication data across the selected secure transmission path.

2. The autonomous quantum-secure mesh networking system (100) of claim 1, wherein the identity-bound key material is derived based on combination of the quantum identity root with at least one selected from: at least one multimodal biometric vector, at least one hardware signature.

3. The autonomous quantum-secure mesh networking system (100) of claim 1, wherein the trust model computes an adaptive trust score based on a federated inference model, the trust score influences the routing preferences and the encryption policies during secure transmission across the selected secure transmission path.

4. The autonomous quantum-secure mesh networking system (100) of claim 1, wherein a metadata encryption process utilizes the symmetric quantum encryption key, at least one quantum entropy-derived parameter and at least one trust score parameter to encrypt the session metadata and encrypted communication data stored in the memory (104).

5. The autonomous quantum-secure mesh networking system (100) of claim 1, wherein the blockchain-based distributed ledger stores at least one key lifecycle event and at least one access policy of the symmetric quantum encryption key.

6. The autonomous quantum-secure mesh networking system (100) of claim 1, wherein the processor (106) receives the entropy values from a quantum random number generator, wherein the received entropy values are transformed into a cryptographic seed that is used to generate the symmetric quantum encryption key.

7. The autonomous quantum-secure mesh networking system (100) of claim 6, wherein the processor (106) validates the entropy values used for generation of the seed, by comparing the received entropy parameters with predefined entropy thresholds, and regenerates entropy within the quantum identity root upon detection of a mismatch or deviation.

8. The autonomous quantum-secure mesh networking system (100) of claim 7, wherein the processor (106) records the entropy fingerprints derived from validated entropy values in the blockchain-based distributed ledger together with temporal event anchors and device identity attributes, thereby enabling origin authenticity and auditability of the generated symmetric quantum encryption key.

9. The autonomous quantum-secure mesh networking system (100) of claim 1, wherein the processor (106) controls the quantum key distribution process to transmit the photons across an optical fiber medium, the processor (106) detects eavesdropping attempts by evaluating a quantum bit error rate, and terminates generation and transmission of the generated symmetric quantum encryption key, if the evaluated quantum bit error rate exceeds a predefined limit.

10. The autonomous quantum-secure mesh networking system (100) of claim 1, wherein the processor (106) coordinates an endpoint-local generation of the symmetric quantum encryption key, the symmetric quantum encryption key being created within both the server (102) and the computing device and not exchanged over the communication network.

11. The autonomous quantum-secure mesh networking system (100) of claim 1, wherein the processor (106) verifies entropy sufficiency during the quantum key distribution process by sampling a quantum entropy output and initiating a regeneration event if entropy falls below a tolerance level.

12. The autonomous quantum-secure mesh networking system (100) of claim 1, wherein the processor (106) optimizes the quantum key distribution process by selecting at least one photon-based transmission path to minimize latency and preserve encryption stability, wherein the at least one photon-based transmission path is selected based on at least one from: a signal-to-noise ratio, an optical loss, an alignment drift, a bit error rate, a temperature fluctuation, a vibration level, photon transmission metrics, a network traffic pattern and a network latency.

13. A method (200) for securely transmitting communication data over a quantum-secure mesh network, the method (200) comprising:
utilizing a server (102) comprising a processor (106) operatively coupled to a memory (104), the processor (106) performs:
receiving, communication data from at least one computing device for secure transmission across a communication network;
generating, a symmetric quantum encryption key using a quantum key distribution process;
deriving, a quantum identity-bound key material by combining the symmetric quantum encryption key with a quantum identity root for authenticating the communication endpoints;
evaluating, a trust score of each available transmission path using a trust model to select a secure transmission path;
encrypting, communication data and associated session metadata using the symmetric quantum encryption key;
record an identifier of each encrypted packet and at least one trust-related parameter of the secure transmission path on a blockchain-based distributed ledger; and
transmitting, the encrypted communication data across the selected secure transmission path.

14. The method of claim 13, further comprising expiring the generated symmetric quantum encryption key after a predefined session duration and regenerating a fresh symmetric quantum encryption key for a remaining session duration.

15. The method of claim 13, further comprising configuring a direct quantum key distribution channel between two endpoints of the communication network to bypass an intermediate routing infrastructure.

16. The method of claim 13, further comprising dynamically rerouting encrypted communication data through an alternative transmission path if the evaluated trust score falls below a preset criterion.

17. The method of claim 13, further comprising configuring a virtualized quantum key distribution tunnel between two endpoints of the communication network to carry at least one of: the session quantum entropy packets, the encrypted communication data, based on the evaluated trust score and channel availability.

18. The method of claim 13, further comprising detecting a side-channel anomaly selected from photon blinding attempts, timing discrepancies, and entropy drift, and regenerating the symmetric quantum encryption key in response.

19. A non-transitory computer-readable storage medium, comprising executable instructions that, when executed by a processing system including a processor (106), facilitate secure transmission of communication data over a quantum-secure mesh network, comprising:
utilizing a server (102), wherein the server (102) comprising the processor (106) operatively coupled to a memory (104), the processor (106) is arranged for:
receiving, the communication data from at least one computing device for secure transmission across a communication network;
generating, a symmetric quantum encryption key using a quantum key distribution process;
deriving, a quantum identity-bound key material by combining the symmetric quantum encryption key with a quantum identity root for authenticating the communication endpoints;
evaluating, a trust score of each available transmission path using a trust model to select a secure transmission path;
encrypting, communication data and associated session metadata using the symmetric quantum encryption key;
record an identifier of each encrypted packet and at least one trust-related parameter of the secure transmission path on a blockchain-based distributed ledger; and
transmitting, the encrypted communication data across the selected secure transmission path.
receiving, communication data from at least one computing device for secure transmission across a communication network;
generating, a symmetric quantum encryption key using a quantum key distribution process;
deriving, a quantum identity-bound key material by combining the symmetric quantum encryption key with a quantum identity root for authenticating the communication endpoints;
evaluating, a trust score of each available transmission path using a trust model to select a secure transmission path;
encrypting, communication data and associated session metadata using the symmetric quantum encryption key;
record an identifier of each encrypted packet and at least one trust-related parameter of the secure transmission path on a blockchain-based distributed ledger; and
transmitting, the encrypted communication data across the selected secure transmission path.
